(19) United States
(12) Patent Application Publication
(10) Pub. No.: US 2025/0132437 A1
(43) Pub. Date: Apr. 24, 2025

(54) BATTERY SYSTEM

(71) Applicants: HYUNDAI MOTOR COMPANY, SEOUL (KR); KIA CORPORATION, SEOUL (KR)

(72) Inventors: Youngmoo Jeon, Incheon (KR); Yeongjun Cheon, Daegu (KR)

(73) Assignees: HYUNDAI MOTOR COMPANY, SEOUL (KR); KIA CORPORATION, SEOUL (KR)

(21) Appl. No.: 18/668,921

(22) Filed: May 20, 2024

(30) Foreign Application Priority Data
Oct. 19, 2023 (KR) 10-2023-0140588

(51) Int. Cl. H01M 50/242; H01M 50/264

(52) U.S. Cl. CPC H01M 50/242; H01M 50/264

(57) ABSTRACT

A battery pack for a vehicle, and more particularly, to a battery system capable of implementing a uniform surface pressure of a lithium metal battery. The battery system includes a plurality of battery cells stacked in a housing, an endplate positioned at one end of the housing, and positioned on a cell disposed at a distal end among the plurality of battery cells, and the endplate being configured to provide a surface pressure toward the plurality of battery cells, a plurality of frames positioned at peripheries of the plurality of battery cells with respect to the plurality of battery cells, a plurality of support bodies connected to the endplate while penetrating the plurality of frames in a direction toward the plurality of battery cells, and a pressure sensor positioned on the endplate.

### CROSS REFERENCE TO RELATED APPLICATIONS

This application claims priority to and the benefit of Korean Patent Application No. 10-2023-0140588 filed in the Korean Intellectual Property Office on Oct. 19, 2023, the entire contents of which are incorporated herein by reference.

### BACKGROUND

### (a) Field

The present disclosure relates to a battery pack for a vehicle, and more particularly, to a battery system capable of implementing a uniform surface pressure of a lithium metal battery.

### (b) Description of the Related Art

Lithium-ion batteries are widely used for various electronic devices such as smartphones, notebook computers, personal computers, tablets, and cameras, movable devices such as electric bicycles and electric scooters, and energy storage systems. Because the lithium-ion battery (LIB) uses a graphite negative electrode, a level of breathing and swelling is not high, a space occupied by a buffer pad is small, and the amount of change in volume and pressure for each cell is small during a process of charging or discharging the cell.

However, an energy density, which enables a large amount of energy to be stored in the same volume, is limited, which makes it difficult to apply the lithium-ion battery to a high-capacity energy storage system.

Therefore, there is a need to develop a battery having a high energy density. Therefore, there is an increasing interest in lithium metal batteries with high energy density. The lithium metal battery (LMB) refers to a rechargeable battery that uses lithium metal as a negative electrode material. The lithium metal battery has a higher energy density and a longer lifespan than the lithium-ion battery (LIB) in the related art. Therefore, the lithium metal battery is of interest in a high-capacity energy storage system of a large-scale movable device such as an electric vehicle.

However, because the lithium metal battery (LMB) uses a lithium negative electrode, instead of a carbon material, as a negative electrode active material, lithium electrodeposition and dendrites occur, a level of breathing and swelling is high, and a space occupied by the buffer pad is large. In addition, a difference in surface pressure between at a BOL (beginning of life) and an EOL (end of life) is large, which causes the acceleration of degradation and the occurrence of a short circuit. For this reason, the configuration of the battery module in which the buffer pad in the related art is inserted is not proper for the lithium metal battery (LMB)

Therefore, there is a need for a new type of system configuration for maintaining a constant surface pressure at the BOL and EOL of the lithium metal battery in which cell swelling is severe.

### SUMMARY

The present disclosure attempts to provide a configuration of a lithium metal battery (LMB) system capable of maintaining a uniform surface pressure even in the event of cell swelling.

In order to achieve the above-mentioned object, the present disclosure may provide the following embodiments.

An exemplary embodiment of the present disclosure provides a battery system including a plurality of battery cells stacked in a housing; an endplate positioned at one end of the housing, positioned on a cell disposed at a distal end among the plurality of battery cells, and configured to provide a surface pressure toward the plurality of cells, frames positioned at peripheries of the battery cells with respect to the plurality of battery cells, a plurality of support bodies connected to the endplate while penetrating the frames in a direction toward the cells, and a pressure sensor positioned on the endplate.

In addition, when the surface pressure to be transmitted to the endplate is changed by swelling of the cells, the system may detect the swelling and adjust the surface pressure of the endplate by changing tension, positions, and/or lengths of the support bodies.

In addition, the support bodies are respectively positioned at one end and the other end of the frame.

In addition, different surface pressures are applied to a surface of the endplate by differently adjusting tension, positions, and/or lengths of the support body positioned at the one end and the support body positioned at the other end. In addition, the support body may be provided in the form of a screw and adjusts the surface pressure of the endplate by rotating the screw.

In addition, the screws may be respectively positioned at one end and the other end of the frame, and the number of screws positioned at one end and the number of screws positioned at the other end may be equal to each other.

In addition, the screws may be respectively positioned at one end and the other end of a long side of the frame.

In addition, the screws independently rotate depending on pressure values of the pressure sensor.

In addition, no surface pressure adjustment pad may be positioned between the battery cells.

In addition, the battery system may maintain the plurality of battery cells with constant sizes in the housing by adjusting the surface pressure of the endplate in response to swelling in accordance with cycles of the cells.

According to the lithium metal battery (LMB) system according to the embodiment of the present disclosure, in case that the surface pressure to be transmitted to the endplate is changed by cell swelling, the lithium metal battery (LMB) system may detect the cell swelling and compose a uniform surface pressure by adjusting the surface pressure of the endplate by changing the tension, position, and/or length of the support body.

### BRIEF DESCRIPTION OF THE FIGURES

The following drawings attached to the present specification illustrate exemplary embodiments of the present disclosure and serve to further understand the technical spirit of the present disclosure together with the following detailed description of the present disclosure, and the present disclosure should not be interpreted as being limited to the items illustrated in the drawings.

FIG. 1A is a top plan view of a uniform surface pressure composition battery system of a BOL (beginning of life) cell according to an embodiment of the present disclosure.

FIG. 1B is a top plan view of the uniform surface pressure composition battery system of an EOL (end of life) cell according to the embodiment of the present disclosure.

FIG. 2 is one side view of the uniform surface pressure composition battery system according to the embodiment of the present disclosure.

FIG. 3 is a top plan view of a lithium metal battery (LMB) module in the related art.

### DETAILED DESCRIPTION

Exemplary embodiments of the present disclosure will be described with reference to the accompanying drawings to sufficiently understand the present disclosure. In this case, the exemplary embodiments to be described below are illustrative for helping understand the present disclosure, and it should be understood that the present disclosure may be carried out by being modified in various ways different from the exemplary embodiments described herein. In addition, to help understand the present disclosure, the accompanying drawings are not illustrated based on actual scales, but some constituent elements may be exaggerated in dimension.

Hereinafter, exemplary embodiments of a uniform surface pressure battery system according to the present disclosure will be described in detail with reference to the accompanying drawings.

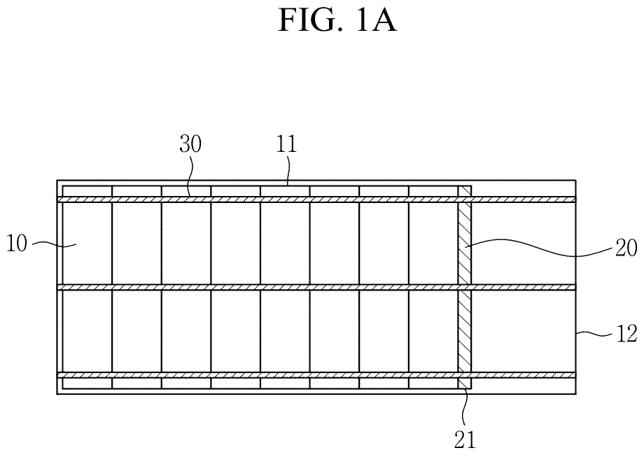

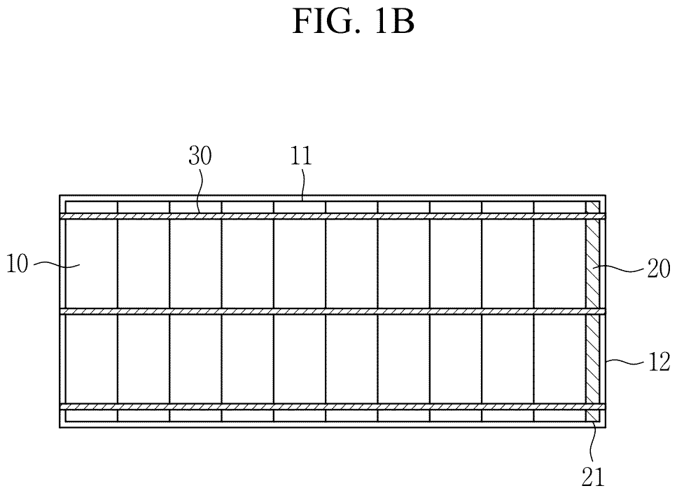

FIG. 1A is a top plan view of a uniform surface pressure composition battery system of a BOL (beginning of life) cell according to an embodiment of the present disclosure, and FIG. 1B is a top plan view of the uniform surface pressure composition battery system of an EOL (end of life) cell according to the embodiment of the present disclosure.

With reference to FIGS. 1A and 1B, a uniform surface pressure composition battery system according to the present disclosure includes a plurality of battery cells 10 stacked in a housing 12, an endplate 20 positioned at one end of the housing 12, positioned on a cell disposed at a distal end among the plurality of battery cells 10, and configured to provide a surface pressure toward the plurality of cells, frames 11 positioned at peripheries of the battery cells with respect to the plurality of battery cells 10, a plurality of support bodies 30 connected to the endplate 20 while penetrating the frames 11 in the direction of the cells, and a pressure sensor 21 positioned on the endplate 20.

In case that the surface pressure to be transmitted to the endplate 20 is changed by swelling of the cells 10, the battery system may detect the swelling and adjust the surface pressure of the endplate 20 by changing tension, positions, and/or lengths of the support bodies 30.

The support bodies 30 may be respectively positioned at one end and the other end of the frame 11. Different surface pressures may be applied to the surface of the endplate 20 by differently adjusting the tension, positions, and/or lengths of the support body positioned at one end and the support body 30 positioned at the other end.

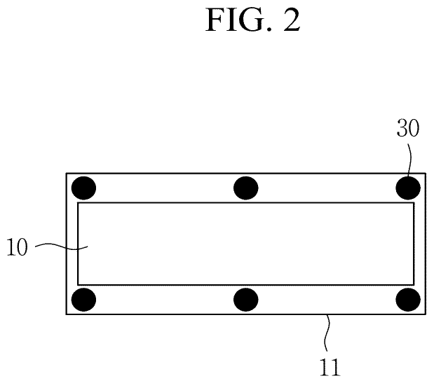

The support body 30 will be described with reference to FIG. 2. FIG. 2 is one side view of the uniform surface pressure composition battery system according to the embodiment of the present disclosure.

With reference to FIG. 2, the support body 30 is provided in the form of a screw and adjusts the surface pressure of the endplate 20 by rotating the screw. The screws are respectively positioned at one end and the other end of the frame 11. The number of screws positioned at one end and the number of screws positioned at the other end are equal to each other. The screws may be respectively positioned at one end and the other end of a long side of the frame 11 and rotated independently depending on pressure values of the pressure sensor 21.

There is no surface pressure adjustment pad between the battery cells 10. The plurality of battery cells 10 with constant sizes may be maintained in the housing 12 by adjusting the surface pressure of the endplate 20 in response to the swelling in accordance with the cycles of the cells 10.

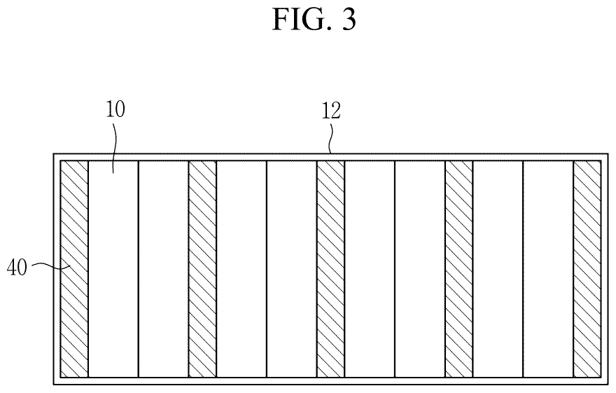

FIG. 3 is a top plan view of a lithium metal battery (LMB) module in the related art.

Surface pressure adjustment pads 40 are provided between the battery cells 10 and the housing 12 in which the plurality of battery cells 10 is provided. The surface pressure adjustment pad 40 serves to adjust the change in volume and pressure for each cell during the process of charging or discharging the cells. However, because the change in breathing and swelling in the lithium metal battery (LMB) is large, a space occupied by the surface pressure adjustment pads 40 is large. Therefore, the battery module configuration in the related art in which the surface pressure adjustment pads 40 are inserted is not proper for the lithium metal battery (LMB).

The above-mentioned embodiments of the battery system capable of maintaining a uniform surface pressure according to the present disclosure are for illustrative purposes only, and those skilled in the art to which the present technology pertains will understand that various modifications of the embodiments and other embodiments equivalent thereto are available.

Accordingly, the true technical protection scope of the present disclosure should be determined by the technical spirit of the appended claims. In addition, it should be understood that the present disclosure includes all modifications, equivalents, and substitutes within the spirit and scope of the present disclosure defined by the appended claims.

1. A battery system comprising:
a plurality of battery cells stacked in a housing;
an endplate positioned at one end of the housing, and positioned on a cell disposed at a distal end among the plurality of battery cells, the endplate being configured to provide a surface pressure toward the plurality of battery cells;
a plurality of frames positioned at peripheries of the plurality of battery cells with respect to the plurality of battery cells;
a plurality of support bodies connected to the endplate while penetrating the plurality of frames in a direction toward the plurality of battery cells; and
a pressure sensor positioned on the endplate.

2. The battery system of claim 1, wherein:
when the surface pressure to be transmitted to the endplate is changed by swelling of the plurality of battery cells, the battery system detects the swelling and adjusts the surface pressure of the endplate by changing tension, positions, or lengths of the plurality of support bodies.

3. The battery system of claim 2, wherein:
the plurality of support bodies are positioned at each end of the frame.

4. The battery system of claim 3, wherein:
different surface pressures are applied to a surface of the endplate by differently adjusting tension, positions, or lengths of the plurality of support bodies.

5. The battery system of claim 1, wherein:
the plurality of support bodies each comprise a screw and are configured to adjust the surface pressure of the endplate by rotating the screw.

6. The battery system of claim 5, wherein:
the screws are positioned at each end of the frame, and a number of screws positioned at one end of the frame is equal to a number of screws positioned at an other end of the frame.

7. The battery system of claim 6, wherein:
the screws are positioned at each end of a long side of the frame.

8. The battery system of claim 7, wherein:
the screws independently rotate depending on pressure values of the pressure sensor.

9. The battery system of claim 1, wherein:
no surface pressure adjustment pad is positioned between the plurality of battery cells.

10. The battery system of claim 1, wherein:
the battery system maintains the plurality of battery cells with constant sizes in the housing by adjusting the surface pressure of the endplate in response to swelling in accordance with cycles of the plurality of battery cells.
